(19) United States
(12) Patent Application Publication
(10) Pub. No.: US 2025/0262887 A1
(43) Pub. Date: Aug. 21, 2025

(54) WHEEL FASTENING SYSTEM

(71) Applicant: MCMURTRY AUTOMOTIVE LIMITED, Wotton-under-Edge Gloucestershire (GB)

(72) Inventors: George Karl SCHOLZ, Wotton-under-Edge Gloucestershire (GB); David Michael TURTON, Wotton-under-Edge Gloucestershire (GB)

(73) Assignee: MCMURTRY AUTOMOTIVE LIMITED, Wotton-under-Edge Gloucestershire, GB (GB)

(21) Appl. No.: 18/857,240

(22) PCT Filed: Apr. 28, 2023
(86) PCT No.: PCT/EP2023/061404

§ 371 Date: Oct. 16, 2024

(30) Foreign Application Priority Data
May 3, 2022 (GB) 2206438.0

(51) Int. Cl. B60B 3/14; B25B 23/00; B60B 29/00; F16H 1/28

(52) U.S. Cl. CPC B60B 3/142; B25B 23/0078; B60B 29/003; F16H 1/28

(57) ABSTRACT

The invention provides a wheel fastening system for a vehicle. An embodiment consistent with the invention includes a hub on which a wheel is mountable, the hub comprising a threaded surface, and a nut which is engageable with the threaded surface to fasten the wheel to the hub. The embodiment further includes a tool including a socket that is engageable with the nut; a reaction element that is engageable with a reaction surface on the hub or the wheel, wherein, when the wheel is mounted on the hub and the nut is engaged with the threaded surface, the socket and the reaction element are simultaneously engageable with the nut and the reaction surface, respectively; and a gearbox configured to simultaneously apply opposing torques to the socket and the reaction element. In this manner, the tool can be used to simultaneously apply opposing torques to the nut and the reaction surface.

### FIELD OF THE INVENTION

The present invention relates to a wheel fastening system for a vehicle, the system including a hub on which a wheel is mountable, a nut for fastening the wheel onto the hub, and a tool for applying a torque to the nut.

### BACKGROUND

A centrelock wheel is a type of vehicle wheel where the wheel is fastened to a wheel hub on the vehicle via a single, central fastening. Typically, a centrelock wheel is mounted on a central shaft of the hub. The shaft of the hub has a threaded surface, on which a nut can be engaged and tightened to clamp the wheel between the nut and hub. This centrelock arrangement is in contrast to the more common arrangement where the wheel is fastened to the hub via multiple (usually four or five) nuts or bolts arranged in a ring around a central axis of the wheel. Centrelock wheels are generally preferred in motorsport applications, as the use of a single nut for fastening the wheel to the hub facilitates rapid removal of the wheel, e.g. during a pitstop. The centrelock design also allows larger brakes to be used, and can provide increased wheel mounting strength. This may enable better handling of the large acceleration and braking torques, as well as lateral cornering forces which occur in motorsport applications.

However, a difficulty associated with centrelock wheels is that a large torque is required to tighten and untighten the nut on the hub, typically of the order of hundreds of Nm. Various techniques exist for applying such large torques to the nut of a centrelock wheel. For example, torque wrenches having a long handle may be used to apply large torques to the nut. However, due to the lengths of their handles, such torque wrenches are unwieldy and can be inconvenient to use. To avoid having to use such a long handle, it is known to fit a torque wrench with a torque multiplier in the form of a gearbox arranged to step up an input torque to a larger output torque. This enables smaller torque wrenches to be used, whilst still achieving the required high levels of torque.

When applying a large torque to a centrelock nut, e.g. using a torque multiplying gearbox, it is necessary to react the torque to ensure that the nut turns in response to the torque and to avoid spinning of the wheel. For example, when the vehicle is on the ground, if a torque required to turn the nut against the wheel is greater than a torque required to turn the wheel against the ground, then when a torque is applied to the nut the wheel will spin rather than the nut being tightened or loosened. This will be an even greater issue where the vehicle is lifted off the ground, as the wheel may spin freely in the air. The wheel may therefore need to be held still when a torque is applied to the nut. This is typically achieved by applying the brakes during application of a torque to the centrelock nut, to avoid wheel spinning. This may require either another person to sit in the vehicle and apply the brakes, or a brake depressor which holds the brake pedal in a depressed position (typically by reacting a pressure of the brake pedal against the steering wheel or the seat). However, requiring another person to sit in the vehicle to apply the brakes may be inefficient and expensive, whilst a brake depressor may cause damage to the steering wheel or seat which it is braced against.

The large torque applied to the nut may also cause a fixed part of the gearbox to rotate instead of the wheel. This issue can be addressed by connecting a reaction bar to a casing of the gearbox, and positioning the reaction bar in contact with the ground such that the gearbox casing is prevented from rotating when a torque is applied to the nut. However, a drawback of using a reaction bar contacting the ground is that, where very large torques are applied, the vehicle may be lifted up by the reaction bar which may be dangerous. Additionally, such a reaction bar cannot be used when the vehicle is lifted into the air for maintenance. An alternative approach is to use a reaction bar connected to the casing of the gearbox, and which is arranged to react against a spoke of the wheel. A drawback of this approach is that it may result in large forces being applied to the wheel spoke, which could result in damage of the wheel. Additionally, such an approach cannot be used with wheels that do not have exposed spokes.

### SUMMARY OF THE INVENTION

At its most general, the present invention provides a tool for applying a torque to a nut of a centrelock wheel, the tool having a socket that is engageable with the nut and a reaction element that is engageable with a reaction surface on a wheel hub or the wheel itself. The tool further comprises a gearbox which is configured to simultaneously apply opposing torques to the socket and the reaction element. In this manner, the tool can be used to simultaneously apply opposing torques to the nut and the reaction surface. The torque applied to the nut may serve to tighten or loosen the nut, whilst the opposing torque applied to the reaction surface (which is on the wheel or hub) acts as a reaction torque which prevents rotation of the wheel and a fixed part of the gearbox. Thus, the tool of the invention may ensure that the wheel and fixed part of the gearbox are held still, whilst the nut is tightened or loosened. Moreover, as the tool's reaction element acts to hold the wheel still whilst a torque is applied to the nut, there may be no need to separately immobilise the wheel, e.g. by applying the brakes as in the prior art. This may also avoid having to use a reaction bar which reacts against the ground or a wheel spoke, such that drawbacks associated with those techniques can be avoided. Accordingly, the tool of the invention may simplify the procedure for tightening and loosening a centrelock nut, thus facilitating rapid installation and removal of a centrelock wheel.

According to a first aspect of the invention, there is provided a wheel fastening system for a vehicle, the wheel fastening system comprising: a hub on which a wheel is mountable, the hub comprising a threaded surface; a nut which is engageable with the threaded surface to fasten the wheel to the hub; and a tool comprising: a socket that is engageable with the nut; a reaction element that is engageable with a reaction surface on the hub or the wheel, wherein, when the wheel is mounted on the hub and the nut is engaged with the threaded surface, the socket and the reaction element are simultaneously engageable with the nut and the reaction surface, respectively; and a gearbox configured to simultaneously apply opposing torques to the socket and the reaction element.

Thus, when the wheel is mounted on the hub, the nut may be engaged with the threaded surface on the hub to fasten the wheel to the hub. The tool can then be arranged such that its socket engages the nut and its reaction element engages the reaction surface, so that the tool can simultaneously apply opposing torques to the nut and the reaction surface, to cause the nut to rotate whilst holding the wheel still. In this manner, the tool may be used to tighten and loosen the nut on the hub, whilst preventing the hub and wheel from turning.

The wheel fastening system may be a centrelock wheel fastening system. In particular, the hub may be configured to receive a centrelock wheel, where the centrelock wheel is mountable on the hub via a centre hole of the wheel.

The hub may serve to connect the wheel to the vehicle. The hub may thus comprise any suitable interface for connecting the hub to a relevant part of the vehicle, such as an axle, suspension upright, and/or steering mechanism of the vehicle.

The hub may comprise a shaft for receiving the wheel. The shaft may be a central shaft, such that the wheel is centred on the hub when the wheel is received on the shaft. For example, the shaft may be configured to fit in a centre hole of the wheel (e.g. of a centrelock wheel). The threaded surface may be provided on the shaft, e.g. on a surface of the shaft. In this manner, when the wheel is received on the shaft, the nut may be engaged with the threaded surface to fasten the wheel to the hub.

The hub may comprise a plate (e.g. disc), to which the wheel can be clamped. Thus, when the wheel is mounted on the hub (e.g. on the shaft of the hub) and the nut is tightened onto the hub, the wheel may be clamped between the nut and the plate. In other words, the plate may act as a reaction surface against which the wheel is secured when the wheel is fastened to the hub.

The hub and wheel may be arranged such that, when the wheel is mounted on the hub, the wheel and hub rotate together, i.e. they rotate as one. For example, the hub may comprise one or more torque transfer elements configured to transfer a torque to the wheel when the wheel is fastened to the hub. The torque transfer elements on the hub may be configured to engage corresponding torque transfer elements on the wheel, to enable transfer of torque between the hub and the wheel. For example, the hub may comprise one or more pins that are configured to engage one or more corresponding holes in the wheel (or vice versa) when the wheel is fastened to the hub, to enable the transfer of torque. The one or more torque transfer elements of the hub may be connected to the plate mentioned above.

The nut is engageable with the threaded surface on the hub to fasten the wheel to the hub. Thus, the nut may include a threaded surface configured to engage (mate) with the threaded surface of the hub, such that the nut can be screwed on to the hub. For example, the nut may include a threaded inner surface.

When the nut is engaged with the threaded surface on the hub, rotation of the nut in a first direction about an axis of the hub may cause tightening of the nut on the hub, whereas rotation of the nut in a second, opposite direction about the axis of the hub may cause loosening of the nut. For example, the first direction may correspond to a clockwise direction, whilst the second direction may correspond to an anti-clockwise direction (or vice versa).

Herein, the axis of the hub may refer to a central axis of the hub, e.g. the axis of the hub may be centred about the shaft of the hub, and extend in a longitudinal direction of the shaft. Thus, the axis of the hub may correspond to an axis of rotation of the wheel when the wheel is mounted on the hub.

The nut may comprise an engagement surface, which is configured to engage the wheel when the wheel is mounted on the hub and the nut is engaged with the threaded surface on the hub, in order to clamp the wheel to the hub as mentioned above.

The socket of the tool is engageable with the nut, such that when the socket is engaged with the nut, the socket can apply a torque to the nut to cause rotation of the nut about the axis of the hub, e.g. to tighten or loosen the nut on the hub. The socket may have a shape that is adapted to a shape of the nut, in order to enable transfer of torque about the axis of the hub from the socket to the nut. For example, the socket may have a shape that is complementary to a shape of the nut, to enable transfer of torque from the socket to the nut when the socket is engaged with the nut.

The reaction element is engageable with a reaction surface on the hub or the wheel, such that when the reaction element is engaged with the reaction surface, the reaction element can apply a torque to the reaction surface, e.g. to prevent the wheel from rotating with the nut. The reaction element and the reaction surface may have shapes that are adapted to one another, to enable transfer of torque about the axis of the hub from the reaction element to the reaction surface. For example, the reaction element and the reaction surface may have shapes that are complementary, to enable transfer of torque from the reaction element to the reaction surface when the reaction element is engaged with the reaction surface.

The socket and the reaction element are arranged so that the socket and the reaction element can be simultaneously engaged with the nut and the reaction surface, respectively. Thus, when the wheel is mounted on the hub and the nut is engaged with the threaded surface on the hub, the tool can be offered towards the hub to bring the socket into engagement with the nut and the reaction element into engagement with the reaction surface. Accordingly, a spatial arrangement of the socket and the reaction element in the tool may be adapted to a spatial arrangement of the nut and the reaction surface when the wheel is mounted on the hub and the nut is engaged with the threaded surface.

The reaction surface is located on the hub or on the wheel, depending on the specific embodiment. As noted above, when the wheel is mounted on the hub, the wheel and the hub may be arranged to rotate together. Thus, when the socket applies a torque to the nut, an opposing torque applied to the reaction surface by the reaction element, may serve to prevent both the wheel and hub from rotating with the nut.

The reaction surface may be formed directly in or on an exposed surface of the hub or wheel. This may serve to simplify the wheel fastening system, as this may avoid having to make any modifications to the nut, e.g. a conventional centrelock nut may be used. This may also avoid adding any mass to the vehicle. In fact, providing the reaction surface on the hub or the wheel may reduce a mass of the vehicle, e.g. where the reaction surface includes an opening or cavity formed in the hub or wheel. The reaction surface may form part of a reaction body on the hub or the wheel, and on which the torque from the reaction element acts.

The socket and the reaction element may both be rotatably mounted relative to a body of the tool, e.g. via any suitable rotatable couplings. Furthermore, the socket and the reaction element may be rotatable relative to one another, i.e. they may each be rotated relative to the body of the tool. The socket and the reaction element may both be rotatable about a common axis, e.g. about a longitudinal axis of the tool. For example, the socket and the reaction element may be concentrically arranged relative to one another. The socket and the reaction element may be arranged such that, when they are respectively engaged with the nut and the reaction surface, the common axis of rotation of the socket and reaction element is aligned with the axis of the hub. In this manner, the socket and the reaction element can each apply a torque to the nut and the reaction surface, respectively.

The gearbox of the tool is coupled to the socket and the reaction element to apply opposing torques to the socket and the reaction element. In other words, the gearbox is arranged to apply torques of substantially similar magnitudes but in opposing directions to the socket and the reaction element. Accordingly, when the socket is engaged with the nut and the reaction element is engaged with the reaction surface, the gearbox may be operated to apply opposing torques to the nut and the reaction surface. The torque applied to the nut may then act to rotate the nut against the wheel (e.g. to tighten or loosen the nut on the hub), whilst the opposing torque applied to the reaction surface acts to prevent the wheel (and the hub) from rotating with the nut.

The gearbox may be housed in the body of the tool. Any suitable gearbox capable of applying opposing torques to the socket and reaction element may be used. The gearbox may comprise an input configured to receive an input torque, and a gear system (i.e. an arrangement of gears) which is configured to convert the input torque into a first output torque applied to the socket and a second output torque applied to the reaction element, the first torque and the second torque being of substantially similar magnitudes and in opposite directions. The input torque may be either supplied manually (e.g. via a wrench), or using a motorised device such as a power tool.

The gear system in the gearbox may comprise a first gear element which is coupled to the socket to apply the first output torque to the socket, and a second gear element which is coupled to the reaction element to apply the first output torque to the reaction element. The second gear element may then correspond to a fixed part of the gear system, as, in use, the reaction element acts to prevent the wheel from turning such that a rotational position of the reaction element may remain substantially constant. On the other hand, the socket may rotate with the nut. In this manner, the fixed part of the gear system may be prevented from rotating or spinning in use.

The gearbox may comprise a torque multiplier, which is configured to receive an input torque and convert the input torque into opposing stepped up torques that are applied to the socket and the reaction element, respectively. In other words, magnitudes of the first output torque applied to the socket and the second output torque applied to the reaction element may be stepped up (i.e. multiplied) compared to the input torque, by a predetermined ratio which depends on an arrangement of gears in the torque multiplier. Any suitable torque multiplier may be used for this purpose. Use of a torque multiplier may therefore reduce a magnitude of the input torque which is required in order to tighten or loosen the nut. Thus, for example, a smaller wrench or power tool may be used for providing the input torque.

In some embodiments, the socket may be arranged concentrically around the reaction element, and the reaction surface may be located on the hub. In this manner, the reaction element may engage directly with the hub to prevent the hub (and wheel) from rotating during tightening or loosening of the nut. Providing the reaction surface on the hub may avoid having to apply a large reactive torque directly to the wheel, thus reducing a risk of wear or damage to the wheel. Additionally, providing the reaction surface on the hub may enable the tool to be made smaller and more compact, as this enables the socket to be arranged around the reaction element. Indeed, when the nut is engaged with the threaded surface on the hub, the nut will be located around the hub, such that the nut will be around the reaction surface. Thus, an outer diameter of the tool may be determined by an outer diameter of the nut, with the reaction element having a smaller diameter that fits within the socket.

Where the reaction surface is on the hub, the reaction surface may be provided on an outwards-facing surface of the hub. In particular, the reaction surface may be located on an outwards-facing surface of the central shaft of the hub. In this manner, the reaction surface may be exposed and easily accessible when the wheel is mounted on the hub and the nut is engaged with the threaded surface.

The socket being arranged concentrically around the reaction element may mean that the socket and the reaction element are centred about a common axis of rotation, with the socket having a larger outer diameter than the reaction element.

In other embodiments, the reaction element may be arranged concentrically around the socket, and the reaction surface may be located on the wheel. In this manner, the reaction element may engage directly with the wheel to prevent the wheel (and hub) from rotating during tightening or loosening of the nut. Providing the reaction surface on the wheel enables the reaction element to be located outside (i.e. around) the socket, so that the reaction element can have a larger diameter. This may facilitate applying a larger torque to the reaction surface with the reaction element, which may facilitate preventing rotation of the wheel during tightening or loosening of the nut. A further benefit of putting the reaction surface on the wheel as opposed to the hub is that this may simplify a construction of the hub, which may make the hub lighter and easier to produce.

Where the reaction surface is on the wheel, the reaction surface may be provided on an outwards-facing surface of the wheel. In this manner, the reaction surface may be exposed and easily accessible when the wheel is mounted on the hub and the nut is engaged with the threaded surface. The reaction surface may be provided in an area of the wheel located between the centre hole of the wheel and spokes of the wheel. In other words, the reaction surface may be located towards a centre of the wheel, where the wheel is strongest. This may minimise a risk of wear or damage to the wheel due to application of torque to the reaction surface. In particular, this may avoid applying a torque to spokes of the wheel, which may be where the wheel is weakest.

The reaction element being arranged concentrically around the socket may mean that the reaction element and the socket are centred about a common axis of rotation, with the reaction element having a larger outer diameter than the socket.

The reaction element may comprise a first set of reaction features which are engageable with a second set of reaction features on the reaction surface. In this manner, when the reaction element is engaged with the reaction surface, the first set of reaction features engages the second set of reaction features to enable transmission of torque from the reaction element to the reaction surface. The first and second sets of reaction features may have any suitable shapes to enable transmission of torque between the two parts. For example, the first set of reaction features may have a shape that is complementary to a shape of the second set of reaction features.

The first set of reaction features may comprise two or more first reaction features arranged around (e.g. spaced about) an axis of rotation of the reaction element (which is aligned with the axis of the hub when the reaction element is engaged with the reaction surface). The second set of reaction features may then comprise a corresponding number second reaction features arranged around (e.g. spaced about) the axis of the hub, in an arrangement that matches the arrangement of the first reaction features. This may facilitate applying a torque to the reaction surface.

Where the reaction surface is on the hub, the second set of reaction features may be located on the hub, e.g. on or in a surface of the hub. Alternatively, where the reaction surface is on the wheel, the second set of reaction features may be located on the wheel, e.g. on or in a surface of the wheel.

The first set of reaction features and the second set of reaction features may be arranged in a ring about a central axis of the hub when the reaction element is engaged with the reaction surface. In other words, the first set of reaction features may be arranged in a ring around the axis of rotation of the reaction element, whilst the second set of reaction features may be arranged in a ring around the axis of the hub. This may serve to ensure effective transmission of torque from the reaction element to the reaction surface, thus improving a reliability with which a rotational position of the hub and wheel can be held whilst the nut is being tightened or loosened. Arranging the first and second sets of reaction features in a ring in this manner may also serve to distribute the torque applied by the reaction element to the reaction surface about the axis of the hub, which may improve a stability with which the position of the hub and wheel can be held, as well as reduce stresses experienced by individual reaction features.

The ring arrangement of the first and second sets of reaction features may be substantially centred about the axis of the hub, when the reaction element is engaged with the reaction surface. For example, the first and second sets of reaction features may be arranged in a circle that is centred about the axis of the hub. The first and second sets of reaction features may be evenly spaced about the axis of the hub, e.g. there may be a common angular spacing between each pair of adjacent reaction features in the first and second sets.

A first one of the first set and the second set of reaction features may include a set of reaction protrusions and a second one of the first set and second set of reaction features may include a set of reaction openings in which the reaction protrusions are engageable. In other words, one of the reaction element and the reaction surface may include reaction protrusions, whilst the other one of the reaction element and the reaction surface may include reaction openings. Thus, when the reaction protrusions are engaged in the reaction openings, torque can be transferred from the reaction element to the reaction surface. The reaction protrusions may be arranged to extend in a direction parallel to the axis of the hub when the reaction element is engaged with the reaction surface, so that they extend into the reaction openings.

The reaction protrusions may have any suitable shape. In some cases, each reaction protrusion may have a rounded (e.g. circular) cross-sectional shape, in a plane normal to the axis of the hub when the reaction element is engaged with the reaction surface. This may facilitate engaging the reaction protrusions in the reaction openings, as this avoids corners or edges on the reactions protrusions which could catch on the reaction openings. Accordingly, a rounded cross-sectional shape of the reaction protrusions may enable rapid and reliable engagement of the reaction element and the reaction surface, which may contribute to reducing an amount of time required to tighten or loosen the nut.

The reaction openings may have a shape that is adapted to receive the reaction protrusions. The reaction openings may be formed as apertures or cavities in the reaction surface. The reaction openings may have a depth that is equal to or greater than a length of the reaction protrusions, so that an entire length of the reaction protrusions can be received in the reaction openings. This may serve to ensure good engagement between the reaction element and the reaction surface, by reducing a risk of the reaction protrusions slipping out of the reaction openings.

Preferably, the reaction protrusions may be located on the reaction element, whilst the reaction openings may be formed in the reaction surface. This may avoid having protrusions on the hub or the wheel, which might risk becoming damaged or worn during use of the vehicle. Additionally, this may avoid adding any mass to the vehicle. Rather the formation of reaction openings in the hub or the wheel may contribute to reducing a mass of the vehicle.

Each of the reaction protrusions may have a length which is equal to or greater than a width of the reaction protrusion. In other words, each reaction protrusion may be at least as long as it is wide. This may serve to reduce a risk of the reaction protrusion from slipping out of a reaction opening when the reaction element is engaged with the reaction surface, thereby improving a reliability of the transfer of torque between the reaction element and the reaction surface. Herein, a length of a reaction protrusion may refer to its length in a direction parallel to the axis of the hub, when the reaction element is engaged with the reaction surface, whilst a width of the reaction protrusion may refer to its width in a direction normal to the axis of the hub.

Each of the reaction protrusions may have an end with a rounded or chamfered edge. This may serve to avoid having a sharp edge at the end of each reaction protrusion, which could catch on the reaction openings and potentially cause damage if a torque is applied when the reaction element is not properly engaged with the reaction surface. Additionally, the rounded or chamfered end of the reaction protrusion may serve to guide the protrusion into the reaction opening, e.g. if the reaction protrusion is not perfectly aligned with the reaction opening. Accordingly, providing each reaction protrusion with an end having a rounded or chamfered edge may enable rapid and reliable engagement of the reaction protrusions in the reaction openings, which may contribute to reducing an amount of time required to tighten or loosen the nut. As an example, each reaction protrusion may have a substantially cylindrical shape. Then, an edge between a side surface and an end surface of each reaction protrusion may be rounded or chamfered. As another example, each reaction protrusion may have a dome-shaped end.

Additionally or alternatively, edges of the reaction openings may be rounded or chamfered, to provide similar effects to rounding or chamfering on the reaction protrusions.

Each of the reaction protrusions may have a cross-sectional area that does not increase towards an end of the reaction protrusion, and/or that tapers towards the end of the reaction protrusion. In other words, the cross-sectional area of a reaction protrusion may remain constant along its length, or it may taper (e.g. decrease) towards its end. Thus, the end of a reaction protrusion may have a cross-sectional area that is the same or smaller than a cross-sectional area of a base of the protrusion. This may facilitate inserting a reaction protrusion into a reaction opening, as well as withdrawing the reaction protrusion from the reaction opening. Additionally, a tapering shape of the reaction protrusion may serve to guide the reaction protrusion into a reaction opening, e.g. where the reaction protrusion is not perfectly aligned with the reaction opening.

Herein, the cross-sectional area of a reaction protrusion may refer to its cross-sectional area in a plane normal to the axis of the hub when the reaction element is engaged with the reaction surface.

Each reaction opening may have an area that is larger than a maximum cross-sectional area of each of the reaction protrusions. This may facilitate introducing the reaction protrusions into the reaction openings, as this may increase a range of positions in which the reaction protrusions can be introduced (i.e. inserted) into the reaction openings. In other words, the larger reaction openings may make it easier to align the reaction protrusions with the reaction openings, such that a user may be able to engage the reaction element with the reaction surface more quickly.

Each reaction opening may have a first angular extent that is larger than a second angular extent of each of the reaction protrusions, the first angular extent and the second angular extent being defined relative to a central axis of the hub when the reaction element is engaged with the reaction surface. In this manner, the reaction openings may accept a range of rotational positions of the reaction element for engaging the reaction protrusions in the reaction openings. In particular, the range of rotational positions in which the reaction protrusions can be engaged in the reaction openings may correspond to a difference between the first angular extent and the second angular extent. This may facilitate aligning the reaction protrusions with the reaction openings, which may increase a speed with which a user can engage the reaction element with the reaction surface. As an example, each reaction opening may be in the form of a groove having an arc-shape which is centred at the axis of the hub and has the first angular extent. Each protrusion may then, for example, have a circular cross-section which is arranged to fit in the groove, in which case a distance along the arc-shape occupied by the circular cross-section would correspond to the second angular extent.

Herein the central axis of the hub corresponds to the axis of the hub mentioned above, i.e. the axis of rotation of the hub.

The tool may further comprise a first anchoring feature that is configured to engage a second anchoring feature on the hub when the socket and the reaction element are engaged with the nut and the reaction surface, respectively. The first anchoring feature may thus act as a further engagement point between the tool and the vehicle, which may serve to stabilise the tool when tightening or loosening the nut. In particular, engagement between the first anchoring feature and the second anchoring feature may serve to maintain a position of the tool relative to the hub, and reduce a risk of the tool slipping when large torques are applied by the socket and reaction element. Accordingly, the first and second anchoring features may improve a reliability and safety of the wheel fastening system. Additionally, the first and second anchoring features may serve to guide the socket and reaction element into engagement with the nut and reaction surface, respectively. For example, when the tool is offered towards the hub along the axis of the hub, the first anchoring feature may engage the second anchoring feature in a manner that guides the tool to bring the socket and reaction element into engagement with the nut and reaction surface, respectively.

The second anchoring feature may be formed on or in an outwards-facing surface of the hub, so that it is exposed and easily accessible. Where the reaction surface is disposed on the hub, the reaction surface may be disposed around the second anchoring feature. For example, the second set of reaction features discussed above may be arranged around the second anchoring feature.

The first anchoring feature may be part of the reaction element. Thus, the first anchoring feature may be integrally formed as part of the reaction element. As a result, when the reaction element is engaged with the reaction surface, the reaction element (and hence the first anchoring feature) may be rotationally coupled to the hub. This arrangement may minimise or avoid stresses in the first anchoring feature cause by the torque applied to the reaction surface by the reaction element. As an example, the first set of reaction features discussed above may be arranged around the first anchoring feature.

A first one of the first anchoring feature and the second anchoring feature may include an anchoring protrusion and a second one of the first anchoring feature and the second anchoring feature may include an anchoring opening in which the anchoring protrusion is engageable. In other words, one of the tool and the hub may comprise an anchoring protrusion, whilst the other one of the tool and the hub may comprise an anchoring opening. The anchoring protrusion may be arranged to extend in a direction parallel to the axis of the hub when the anchoring protrusion is engaged in the anchoring opening, e.g. so that the anchoring protrusion can be engaged in the anchoring opening by offering the tool to the hub along the axis of the hub. The anchoring opening may be formed as an aperture or a cavity which is arranged to receive the anchoring protrusion. Where the anchoring opening is formed as a cavity, a depth of the cavity may be equal to or greater than a length of the anchoring protrusion, so that an entire length of the anchoring protrusion can be received in the cavity.

The anchoring opening may be arranged to form a loose fit with the anchoring protrusion, which may facilitate engaging the anchoring protrusion in the anchoring opening. For example, an area of the anchoring opening may be (slightly) larger that a cross-sectional area of the anchoring protrusion.

The anchoring protrusion may be arranged such that the anchoring protrusion engages (i.e. enters) the anchoring opening before the socket and the reaction element engage the nut and the reaction surface, respectively, when the tool is offered towards the hub along the axis of the hub. For example, a length of the anchoring protrusion may be arranged such that the anchoring protrusion engages (i.e. enters) the anchoring opening before the socket and the reaction element engage the nut and the reaction surface, respectively, when the tool is offered towards the hub along the axis of the hub. In this manner, engagement of the anchoring protrusion in the anchoring opening may act to guide the tool when the tool is offered towards the hub. This may serve to ensure that the tool is appropriately positioned, to facilitate engaging the nut and the reaction surface by the socket and reaction element, respectively. In particular, engagement of the anchoring protrusion in the anchoring opening may act to locate the tool relative to the hub and the wheel, so that the socket and reaction element are positioned to engage the nut and the reaction surface (respectively) when the tool is moved towards the hub. Accordingly, the anchoring protrusion and the anchoring opening may facilitate rapid engagement of the socket and reaction element with the nut and reaction surface, respectively.

Where the reaction element or reaction surface includes reaction protrusions, a length of the anchoring protrusion may be greater than a length of the reaction protrusions. This may serve to ensure that the anchoring protrusion engages the anchoring opening before the reaction protrusions engage the reaction openings. Accordingly, engagement of the anchoring protrusion in the anchoring opening may guide positioning of the tool prior to engagement of the reaction protrusions in the reaction openings, in line with the discussion above.

The first anchoring feature may be arranged so that it is centred about the central axis of the hub when the socket and the reaction element are engaged with the nut and the reaction surface, respectively. Accordingly, the second anchoring feature may be centred about the axis of the hub. In this manner, engagement between the first and second anchoring features may act to centre the tool relative to the axis of the hub, which may facilitate applying opposing torques to the nut and the reaction surface about the axis of the hub. Moreover, centring the first anchoring feature relative to the hub may improve stability of the tool when opposing torques are applied to the socket and the reaction element. In particular, engagement of the first anchoring feature with the second anchoring feature may provide a stabilising lateral reaction in response to application of the torques, to maintain engagement of the socket and reaction element with the nut and reaction surface, respectively.

The first anchoring feature and the second anchoring feature may have circular cross-sections. This may facilitate engaging the first anchoring feature and the second anchoring feature, as they may not require a specific rotational relationship to be engaged due to their circular cross-sections. In other words, the first and second anchoring features may act to centre the tool about the hub, without requiring the first anchoring feature to be in a specific rotational position relative to the hub. This may promote easy and rapid engagement of the first and second anchoring features, to guide the socket and reaction element into engagement with the nut and reaction surface, respectively. Moreover, the circular cross-sectional shapes of the first and second anchoring features may avoid any torque about the axis of the hub being transmitted between the first and second anchoring features. For instance, if the hub rotates when the first and second anchoring features are engaged, this may not result in a torque being transferred to the tool via the first anchoring feature (and vice versa).

As an example, where the first anchoring feature and the second anchoring feature include an anchoring protrusion and an anchoring opening, the anchoring protrusion may be a cylindrical protrusion, whilst the anchoring opening may be a circular opening shaped to receive the cylindrical protrusion.

Edges of the anchoring protrusion and/or the anchoring opening may be rounded or chamfered. This may serve to facilitate engagement of the anchoring protrusion in the anchoring opening. For example, the rounded or chamfered edges may act to guide the anchoring protrusion into the anchoring opening. Additionally, this may avoid any sharp edges on the anchoring protrusion and/or anchoring opening which might catch or risk causing damage if a torque is applied when the anchoring protrusion is not properly engaged in the anchoring opening.

A first one of the first anchoring feature and the second anchoring feature comprises an engagement mechanism configured to releasably engage a side surface of a second one of the first anchoring feature and the second anchoring feature when the first anchoring feature is engaged with the second anchoring feature. The engagement mechanism may serve to provide a tight fit between the first and second anchoring features when they are engaged with one another. This may serve to provide secure engagement between the first and second anchoring features, and minimise relative movement between the two parts. In particular, by engaging the side surface, the engagement mechanism may act to grip the second one of the first and second anchoring features. As a result, a stability with which the tool is held on the hub may be improved. The engagement mechanism may be operable between an engaged state, in which it is arranged to engage the side surface, and disengaged (i.e. released) state in which it is arranged to be disengaged from the side surface. This may facilitate installing and removing the tool on the hub, whilst ensuring that the first anchoring feature and the second anchoring feature are securely engaged during use of the tool to tighten or loosen the nut. For example, the engagement mechanism may be put in the disengaged state when the first and second anchoring features are to be engaged or disengaged with one another, e.g. when the tool is being moved towards or away from the hub. The engagement mechanism may then be put in the engaged state when the first and second anchoring features are engaged and the tool is to be used for tightening or loosening the nut.

Such an engagement mechanism may be particularly useful in embodiments where an area of the anchoring opening is larger than a cross-sectional area of the anchoring protrusion, e.g. to provide a loose fit around the anchoring protrusion. Indeed, the larger area of the anchoring opening may facilitate engaging the anchoring protrusion in the anchoring opening, whilst the engagement mechanism may serve to ensure that the anchoring protrusion can be firmly held in the anchoring opening.

The engagement mechanism may comprise a ball detent mechanism. This may provide a convenient mechanism for strengthening the engagement between the first and second anchoring features. The ball detent mechanism may comprise one or more ball bearings in the first one of the first anchoring feature and the second anchoring feature which are arranged to press against the side surface of second one of the first anchoring feature and the second anchoring feature. For example, the ball detent mechanism may be located in the anchoring protrusion, with the one or more ball bearings being arranged to press against a side surface of the anchoring opening when the anchoring protrusion is received in the anchoring opening.

The socket may comprise a set of socket features which are engageable with a set of engagement features on the nut. In this manner, the socket features may be engaged with the engagement features on the nut to enable transfer of torque from the socket to the nut. The socket features may be adapted to a shape of the engagement features on the nut, to enable the transfer of torque. The socket features may be disposed on a socket body, which is rotatably connected to a main body of the tool. The engagement features on the nut may be disposed on an outer face of the nut, i.e. on a face of the nut that faces away from the wheel when the wheel is mounted on the hub and the nut is engaged on the threaded surface of the hub.

The set of socket features may comprise two or more socket features arranged around (e.g. spaced about) an axis of rotation of the socket (which is aligned with the axis of the hub when the socket is engaged with the nut). The set of engagement features may then comprise a corresponding number of engagement features on the nut arranged around (e.g. spaced about) the axis of the hub when the nut is engaged with the threaded surface on the hub, in an arrangement that matches the arrangement of the socket features. This may facilitate applying a torque to the nut with the socket to tighten or loosen the nut.

The set of socket features and the set of engagement features may be arranged in a ring about the central axis of the hub when the socket is engaged with the nut. In other words, the set of socket features may be arranged in a ring about an axis of rotation of the socket, and the set of engagement features may be arranged in a ring about the axis of the hub. This may serve to ensure effective transmission of torque from the socket to the nut, thus improving a reliability with which the nut can be rotated about the axis of the hub by the socket. Arranging the set of socket features and the set of engagement features in a ring in this manner may also serve to distribute the torque applied by the socket to the nut about the axis of the hub, which may facilitate tightening and loosening of the nut, as well as reduce stresses experienced by individual socket features and engagement features.

The ring arrangement of the set of socket features and the set of engagement features may be substantially centred about the axis of the hub, when the socket is engaged with the nut. For example, the set of socket features and the set of engagement features may be arranged in a circle that is centred about the axis of the hub. The set of socket features and the set of engagement features may be evenly spaced about the axis of the hub.

A first one of the set of socket features and the set of engagement features may include a set of engagement protrusions and a second one of the set of socket features and the set of engagement features may include a set of engagement openings in which the engagement protrusions are engageable. In other words, one of the socket and the nut may include engagement protrusions, whilst the other one of the socket and the nut may include engagement openings. Thus, when the engagement protrusions are engaged in the engagement openings, torque can be transferred from the socket to the nut. The engagement protrusions may be arranged to extend in a direction parallel to the axis of the hub when the socket is engaged with the nut, so that they extend into the engagement openings.

The engagement protrusions may have any suitable shape. In some cases, each engagement protrusion may have a rounded (e.g. circular) cross-sectional shape, in a plane normal to the axis of the hub when the socket is engaged with the nut. This may facilitate engaging the engagement protrusions in the engagement openings, as this avoids corners or edges on the engagement protrusions which could catch on the engagement openings. Accordingly, a rounded cross-sectional shape of the engagement protrusions may enable rapid and reliable engagement of the socket and the nut surface, which may contribute to reducing an amount of time required to tighten or loosen the nut.

The engagement openings may have a shape that is adapted to receive the engagement protrusions. The engagement openings may be formed as apertures or cavities in a surface of the socket or the nut (depending on which component the engagement openings are located). The engagement openings may have a depth that is equal to or greater than a length of the engagement protrusions, so that an entire length of the engagement protrusions can be received in the engagement openings. This may serve to ensure good engagement between the socket and the nut, by reducing a risk of the engagement protrusions slipping out of the engagement openings.

Preferably, the engagement protrusions may be located on the socket, whilst the engagement openings may be formed in an outer surface of the nut. This may avoid having protrusions on the nut, which might risk becoming damaged or worn during use of the vehicle. Additionally, this may avoid adding any mass to the vehicle. Rather the formation of engagement openings in the nut may make the nut lighter, thus reducing a mass of the vehicle.

Each of the engagement protrusions may have an end with a rounded or chamfered edge. This may serve to avoid having a sharp edge at the end of each engagement protrusion, which could catch on the engagement openings and potentially cause damage if a torque is applied when the socket is not properly engaged with the nut. Additionally, the rounded or chamfered end of the engagement protrusion may serve to guide the protrusion into the engagement opening, e.g. if the engagement protrusion is not perfectly aligned with the engagement opening. Accordingly, providing each engagement protrusion with an end having a rounded or chamfered edge may enable rapid and reliable engagement of the engagement protrusions in the engagement openings, which may contribute to reducing an amount of time required to tighten or loosen the nut. As an example, each engagement protrusion may have a dome-shaped end.

Additionally or alternatively, edges of the engagement openings may be rounded or chamfered, to provide similar effects to rounding or chamfering on the engagement protrusions.

Each of the engagement protrusions may have a cross-sectional area that does not increase towards an end of the engagement protrusion, and/or that tapers towards an end of the engagement protrusion. In other words, the cross-sectional area of an engagement protrusion may remain constant along its length, or it may taper (e.g. decrease) towards its end. Thus, the end of an engagement protrusion may have a cross-sectional area that is the same or smaller than a cross-sectional area of a base of the protrusion. This may facilitate inserting an engagement protrusion into an engagement opening, as well as withdrawing the engagement protrusion from the engagement opening. Additionally, a tapering shape of the engagement protrusion may serve to guide the engagement protrusion into an engagement opening, e.g. where the engagement protrusion is not perfectly aligned with the engagement opening.

Herein, the cross-sectional area of an engagement protrusion may refer to its cross-sectional area in a plane normal to the axis of the hub when the socket is engaged with the nut, the nut being engaged with the threaded surface on the hub.

Each engagement opening may have an area that is larger than a maximum cross-sectional area of each of the engagement protrusions. This may facilitate introducing (e.g. inserting) the engagement protrusions into the engagement openings, as this may increase a range of positions in which the engagement protrusions can be introduced into the engagement openings. In other words, the larger engagement openings may make it easier to align the engagement protrusions with the engagement openings, such that a user may be able to engage the socket with the nut more quickly.

The gearbox may comprise a planetary gear system. The planetary gear system may enable an input torque to be stepped up (i.e. multiplied), and applied in opposing directions to the socket and the reaction element, respectively. Thus, a planetary gear system may provide a compact and efficient system for providing torque multiplication and generation of opposing torques. This may serve to simplify a construction of the tool, and reduce its size.

A planetary gear system is a gear system which comprises a sun gear and one or more planet gears which mesh with the sun gear, such that centres of the one or more planet gears can rotate around a centre of the sun gear, e.g. the one or more planet gears may roll around the sun gear. The one or more planet gears may be mounted on a planet carrier, which is arranged to rotate with the one or more planet gears around the sun gear. Additionally, the planetary gear system may comprise a ring gear, which meshes with the one or more planet gears. In other words, each planet gear may be meshed between the sun gear and the ring gear.

In some embodiments, the planetary gear system may comprise a sun gear, a ring gear and one or more planet gears, and an input of the gearbox may be connected to the sun gear, one of the socket and the reaction element may be connected to the ring gear, and another one of the socket and the reaction element may be connected to the one or more planet gears. In this manner, an input torque applied to the input of the gearbox may be transmitted to the sun gear, resulting in a first output torque being applied to the ring gear and a second output torque being applied to the one or more planet gears. The first and second output torques will be in opposing directions, and have magnitudes that are stepped up relative to the input torque by a predetermined ratio that depends on numbers of teeth on the various gears in the gear system. The part of the gear system which is connected to the reaction element may act as a fixed part of the gear system, as, in use, engagement of the reaction element with the reaction surface may prevent the reaction element from rotating.

Where the reaction element is connected to the one or more planet gears, the reaction element may be connected to the planet carrier (which is itself connected to the one or more planet gears). On the other hand, where the socket is connected to the one or more planet gears, the socket may be connected to the planet carrier.

The system may further comprise a motor configured to apply a torque to an input of the gearbox. In this manner, the gearbox may be driven by a motor, which may facilitate tightening and loosening of the nut, as well as increase a speed with which the nut can be tightened or loosened on the hub with the tool. The motor may be any suitable motor for generating a torque. For example, the motor may be in the form of a power tool which is coupled to the input of the gearbox.

The wheel fastening system of the first aspect of the invention may form part of a vehicle according to a second aspect of the invention. Thus, according to a second aspect of the invention, there is provided a vehicle comprising a wheel fastening system according to the first aspect of the invention. Any of the features discussed above in relation to the first aspect of the invention may be shared with the second aspect of the invention.

The wheel fastening system may be arranged to fasten a wheel to the vehicle. Each wheel of the vehicle may be mountable on a respective hub of the vehicle, and fastened on the hub via a respective nut, as discussed above in relation to the first aspect of the invention. The tool may then be used to tighten and/or loosen a nut on each hub.

The vehicle may be any type of vehicle, such as a car (e.g. a road car or a race car), an off-road vehicle, or a truck.

Herein, a length of a component may generally refer to a length of that component in a direction parallel to the axis of the hub, unless context dictates otherwise. Likewise, a width of a component may generally refer to a width of that component in a direction normal to the axis of the hub, unless context dictates otherwise. Additionally, a cross-sectional area of a component may refer to a cross-sectional area in a plane normal to the axis of the hub, unless context dictates otherwise.

### BRIEF DESCRIPTION OF THE DRAWINGS

Embodiments of the invention are discussed below with reference to the accompanying drawings, in which:

FIG. 1 is a schematic diagram showing a cross-sectional side view of a system according to an embodiment of the invention;

FIG. 2a is a schematic diagram showing a cross-sectional side view of a hub, which is part of the system of FIG. 1;

FIG. 2b is a schematic diagram showing a plan front view of the hub of FIG. 2a;

FIG. 3a is a schematic diagram showing a plan front view of a nut, which is part of the system of FIG. 1;

FIG. 3b is a schematic diagram showing a cross-sectional side view of the nut of FIG. 3a;

FIG. 4a is a schematic diagram showing a cross-sectional side view of a tool, which is part of the system of FIG. 1;

FIG. 4b is a schematic diagram showing a plan front view of the tool of FIG. 4b;

FIGS. 5a and 5b are schematic diagrams showing side cross-sectional views of a reaction element that may be part of a system according to the invention;

FIG. 6a is a schematic diagram showing a plan front view of a gear system that may be part of a tool in a system according to the invention; and

FIG. 6b is a schematic diagram showing a cross-sectional side view of the gear system of FIG. 6a.

### DETAILED DESCRIPTION; FURTHER OPTIONAL FEATURES

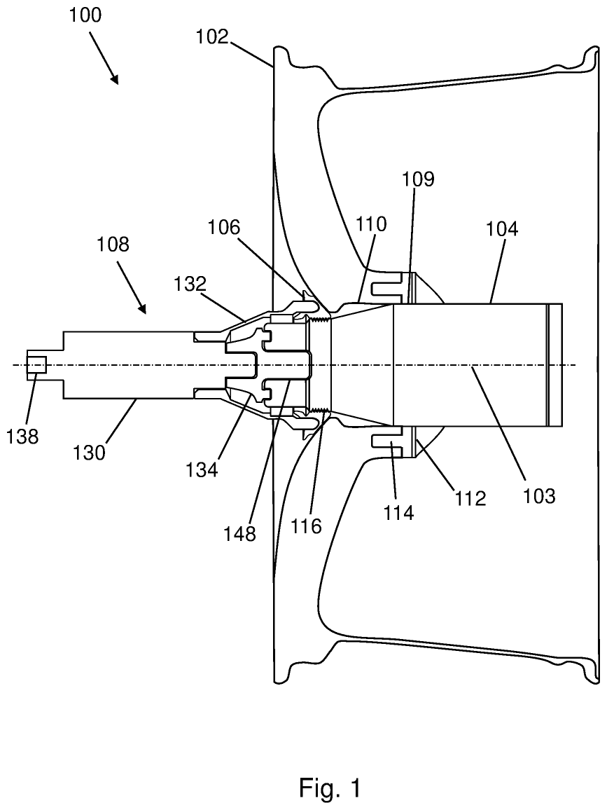

FIG. 1 shows a cross-sectional view of a wheel fastening system 100 according to an embodiment of the invention. The wheel fastening system 100 is configured to fasten a wheel 102 to a vehicle (not shown). The wheel fastening system 100 is a centrelock fastening system, as the wheel 102 is fastened to a hub 104 using a single central nut 106. The wheel fastening system 100 further comprises a tool 108 for tightening and loosening the nut 106. The cross-sectional view of FIG. 1 is taken in a plane that includes a central axis 103 of the hub 104. The central axis 103 of the hub 104 corresponds to an axis of rotation of the wheel 102 when the wheel 102 is mounted on the hub 104. For illustration purposes, no tire is shown on the wheel 102 in FIG. 1.

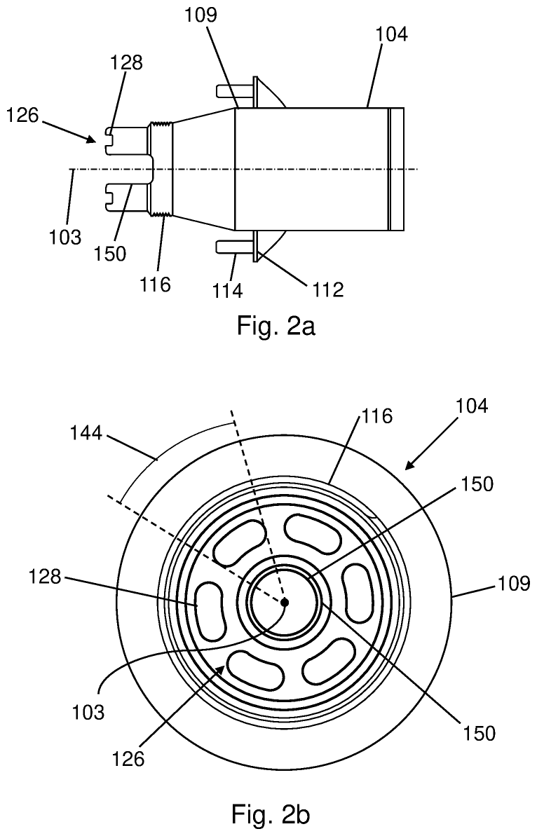

The wheel fastening system 100 includes the hub 104, on which the wheel 102 is mountable. The hub 104 is illustrated on its own in FIG. 2a, which shows a side cross-sectional view of the hub 104. The hub 104 includes a central shaft 109 which is configured to be received in a centre hole 110 of the wheel 102. An outer diameter of the central shaft 109 may substantially match a diameter of the centre hole 110 of the wheel 102, so that the wheel 102 can be mounted onto the central shaft 109. The hub 104 further includes a plate 112 to which the wheel 102 is clamped when the wheel 102 is mounted on the hub 104. Note that in practice the wheel 102 may not be in direct contact with the plate 112, as a brake disc (not shown) may be located between the wheel 102 and the plate 112. The plate 112 includes a series of pins 114 which are configured to be received in corresponding apertures or channels in the wheel 102 when the wheel 102 is mounted on the hub 104, to enable transmission of torque from the hub 104 to the wheel 102. FIG. 2b shows a front plan view of the hub 104, corresponding to a view of the hub 104 looking along the axis 103 towards the hub 104 from the left hand side of FIG. 2a. For illustration purposes, the plate 112 and the pins 114 are not depicted in FIG. 2b. The hub 104 includes an outwards facing reaction surface 126, located on an end face of the hub 104 that faces away from the wheel 102, i.e. towards an outside of the vehicle. The reaction surface 126 includes a plurality of reaction openings 128, in the form of cavities in the end face of the hub 104. The reaction openings 128 are arranged in a circle around the axis 103 of the hub 104.

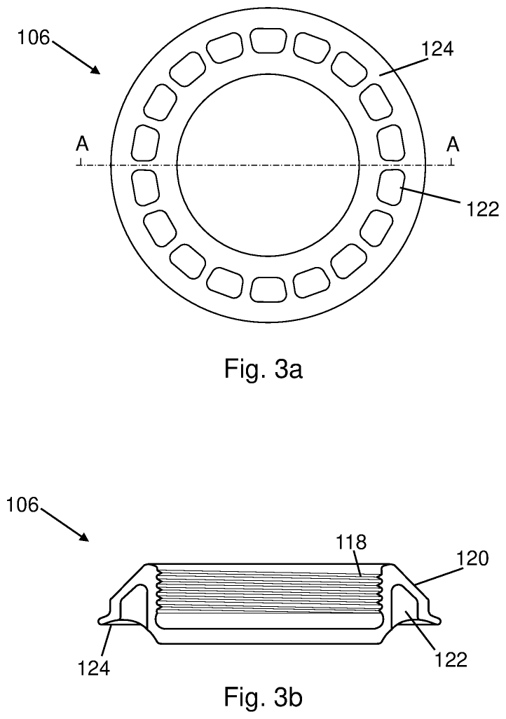

The nut 106 is illustrated in FIGS. 3a-3b, with FIG. 3a showing a view of an external-facing side of the nut 106, and FIG. 3b showing a cross-sectional side view of the nut 106. The cross-sectional view of FIG. 3b is taken along the plane A-A shown in FIG. 3a. In use, the external-facing side of the nut 106 faces away from the wheel (e.g. towards an outside of the vehicle), whilst an opposing wheel-facing side of the nut 106 faces towards a wheel mounted on the hub 104 (e.g. wheel 102). The nut 106 is engageable with a threaded surface 116 provided on an outer surface of the central shaft 109, such that the nut 106 can be screwed on to the central shaft 109. In particular, the nut 106 includes a central hole having a threaded inner surface 118 which is configured to engage (i.e. mate with) the threaded surface 116 on the central shaft 109. The nut 106 further includes a clamping surface 120 located on its wheel-facing side, the clamping surface 120 being configured to abut a surface on the wheel 102 located around its centre hole 110. In this manner, when the wheel 102 is mounted on the central shaft 109 and the nut 106 is screwed onto the threaded surface 116, the clamping surface 120 abuts the wheel 102. The nut 106 can then be tightened, in order to clamp the wheel 102 between the nut 106 and the plate 112, so that the wheel 102 is securely held on the hub 104, as shown in FIG. 1. The clamping surface 120 of the nut 106 may be slanted relative to the central axis 103 of the hub 104, so that it can act as a wedge against the corresponding surface on the wheel 102 around its centre hole 110 to firmly hold the wheel 102 in place on the central shaft 109. In the embodiment shown, the nut also includes engagement features in the form of a plurality of engagement openings (e.g. apertures or channels) 122 formed on an outer face 124 on the external-facing side of the nut 106. The plurality of engagement openings 122 are disposed in a circular arrangement around the central hole of the nut 106. The plurality of engagement openings 122 may facilitate applying a torque to the nut 106 by engaging the tool 106 in the engagement openings 122, as discussed in more detail below. Other types of engagement features may be provided on the external-facing side of the nut 106 to facilitate applying a torque to the nut 106, such as protrusions in the outer face 124, and/or flat edges around a periphery of the nut 106.

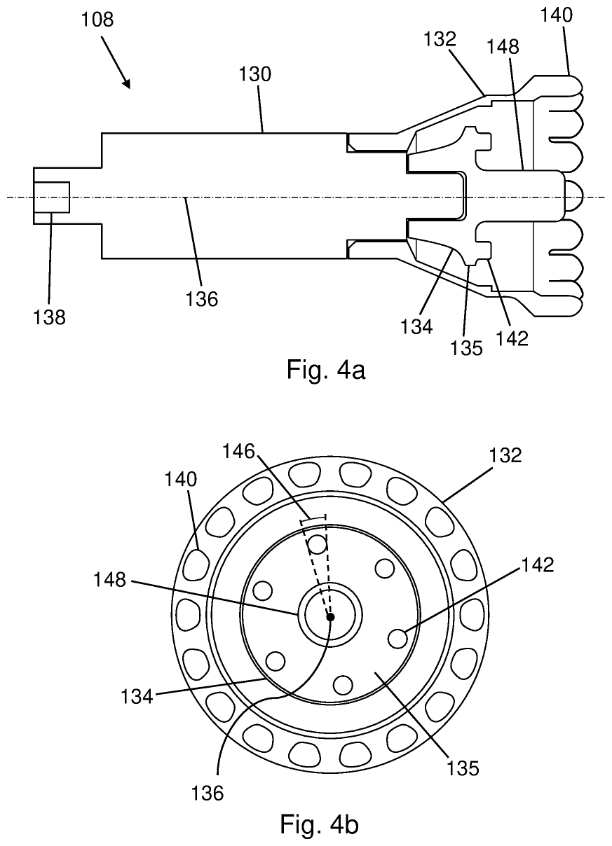

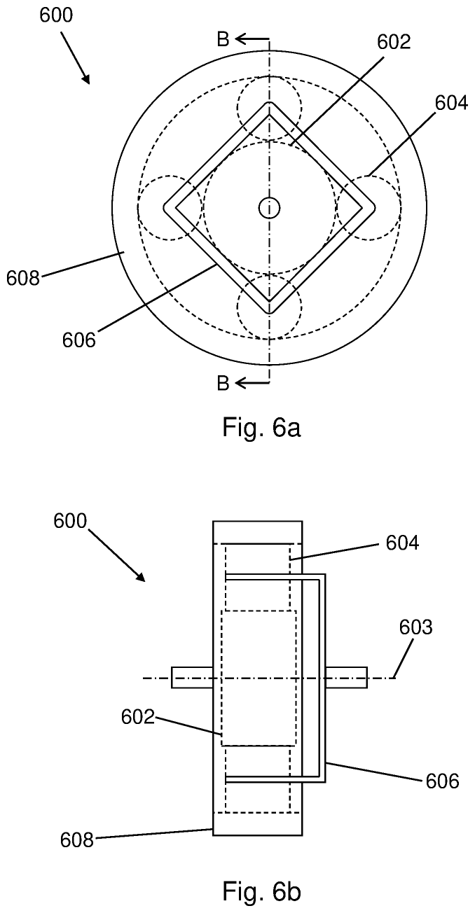

The tool 108 is illustrated in FIGS. 4a-4b, with FIG. 4a showing a cross-sectional side view of the tool 108, and FIG. 4b showing a plan view of an output end of the tool 108. The tool 108 comprises a body 130 in which a gearbox (not shown) is located. A socket 132 and a reaction element 134 are each rotatably mounted at an output end of the body 108. In particular, the socket 132 and the reaction element 134 are both rotatable about a common rotation axis 136, which in the example shown corresponds to a longitudinal axis of the tool 108. The view of FIG. 4b is taken along the axis 136, looking towards the output end of the tool 108 (i.e. from the right-hand side in FIG. 4a). The socket 132 is arranged concentrically around the reaction element 134, such that a sidewall of the socket 132 extends around a portion of the reaction element 134. The socket 132 and the reaction element 134 may each be connected to the body 130 via any suitable rotatable couplings. The gearbox is configured to simultaneously apply opposing torques about the axis 136 to the socket 132 and the reaction element 134. More specifically, the gearbox is arranged to receive an input torque from an input fitting 138 disposed at an input end of the body 130 (opposite its output end), and convert the input torque into a first output torque applied to the socket 132 and into a second output torque applied to the reaction element 134, the first and second output torques being in opposite directions. The input fitting 138 may be any suitable fitting capable of receiving an input torque, e.g. from a handle, a wrench or a power tool. For example, the input fitting may be a ½ inch drive. In addition to converting the input torque into the first and second output torques, the gearbox may also step up the input torque, such that a magnitude of the first and second output torques is stepped up relative to the input torque by a predetermined ratio. An example gearbox for the tool 108 is described below in relation to FIGS. 6a and 6b.

The socket 132 is engageable with the nut 106, so that the socket 132 can apply a torque to the nut 106. In particular, the socket 132 includes a set of socket features in the form of a plurality of engagement protrusions 140 located at a distal end of the socket, which are engageable in the engagement openings 122 on the outer face 124 of the nut 106. The engagement protrusions 140 are disposed in a circular arrangement around the rotation axis 136, which matches that of the circular arrangement of the engagement openings 122. Thus, the plurality of engagement protrusions 140 can be engaged in the engagement openings 122, so that a torque can be transferred from the socket 132 to the nut 106, e.g. in order to tighten or loosen the nut 106 on the hub 104. As shown in FIG. 4b, the engagement protrusions 140 have a cross-section (in a plane normal to the axis 136) that is rounded, i.e. which does not have sharp corners or edges. Additionally, as shown in FIG. 4a, each engagement protrusion 140 has a rounded (e.g. dome-shaped) tip, such that each engagement protrusion 140 tapers towards its tip. This shape of the engagement protrusions 140 may facilitate engaging the engagement protrusions 140 in the engagement openings 122, as the rounded tips and edges of the engagement protrusions 140 may avoid the engagement protrusions 140 catching on parts of the nut 106, and they may serve to guide the engagement protrusions 140 into the engagement openings 122. The engagement openings 122 may also have rounded corners, as shown in FIG. 3a, to facilitate insertion of the engagement protrusions 140.

The reaction element 134 is engageable with the reaction surface 126 on the hub 104, so that the reaction element 134 can apply a torque to the reaction surface 126 (and thus to the hub 104). More specifically, the reaction element 134 includes a set of reaction features in the form of a plurality of reaction protrusions 142 which are engageable in the reaction openings 128. The reaction protrusions 142 are disposed in a circular arrangement around the rotation axis 136, which matches the circular arrangement of the reaction openings 128. The reaction protrusions 142 extend in a longitudinal direction (i.e. parallel to the axis 136) from a base 135 of the reaction element 134. Thus, the plurality of reaction protrusions 142 can be engaged in the reaction openings 128 so that a torque can be transferred from the reaction element 134 to the reaction surface 126. In the example shown, each reaction protrusion 142 each has a substantially cylindrical shape, with an edge between a side surface and end face of the protrusion being rounded or chamfered. This is to avoid the presence of sharp edges at the ends of the reaction protrusions 142. As can be seen when comparing FIGS. 2b and 4b, an area of each reaction opening 128 is larger than a cross-sectional area of each reaction protrusion 142. In particular, each reaction opening 128 is formed as an arc-shaped groove centred on the axis 103 of the hub 104, and has a first angular extent 144 relative to the axis 103 of the hub 104. Each reaction protrusion 142 has a circular cross-section (as it is cylindrical), and has a second angular extent 146 relative to the axis 136, the second angular extent 146 being smaller than the first angular extent 144. As the reaction protrusions 142 each have a smaller angular extent 146 than the reaction openings 142, the reaction protrusions 142 can be engaged in the reaction openings over a range of rotational positions of the reaction element 134, thus facilitating rapid engagement of the reaction element 134 with the reaction surface 126.

The reaction element 134 further comprises a first anchoring feature, in the form of an anchoring protrusion 148 that extends longitudinally from the base 135 of the reaction element 134. The anchoring protrusion 148 is centred about the axis 136, and has a substantially cylindrical shape. Thus, the reaction protrusions 142 are arranged in a ring around the anchoring protrusion 148. Similarly to the reaction protrusions 142, an edge between a side surface and end face of the anchoring protrusion 148 may be rounded or chamfered. The hub 104 comprises a second anchoring feature, in the form of an anchoring opening 150 which is arranged to receive the anchoring protrusion 148. The anchoring opening 150 is a cavity with a circular cross-section formed in the hub 104, and centred about the axis 103 of the hub such that the reaction openings 128 are arranged in a ring around the anchoring opening 150. Accordingly, the reaction protrusions 142 and the anchoring protrusion 148 on the reaction element 134 are arranged to simultaneously engage the reaction openings 128 and the anchoring opening 150 on the hub 104, respectively.

The socket 132 and the reaction element 134 are arranged to simultaneously engage the nut 106 and the reaction surface 126, when the nut 106 is engaged with the threaded surface 116 on the hub 104. In particular, when the tool 108 is offered (e.g. approached) towards the hub 104 along the axis 103 of the hub, the engagement protrusions 140 on the socket 132 may engage the engagement openings 122 on the nut 106, whilst the reaction protrusions 142 and the anchoring protrusion 148 on the reaction element 134 engage the reaction openings 128 and the anchoring opening 150 on the hub 104, respectively. In this manner, a first torque can be applied to the nut 106 via the socket 132, whilst a second torque may be simultaneously applied to the reaction surface 126 (i.e. the hub 104) via the reaction element 134. FIG. 1 shows the tool 108 in a position where the socket 132 and the reaction element 134 are engaged with the nut 106 and the reaction surface 126, respectively. The anchoring protrusion 148 is arranged such that it engages (i.e. enters) the anchoring opening 150 before the socket 132 engages the nut 106 and before the reaction protrusions 142 engage the reaction openings 128. In particular, as can be seen in FIG. 4a, the anchoring protrusion 148 has a greater length than the reaction protrusions 142. In this manner, when the tool 108 is offered towards the hub 104, the anchoring protrusion 148 may enter the anchoring opening 150 and guide the tool 108 to facilitate engagement of the socket 132 and the reaction element 134 with the nut 106 and the reaction surface 126, respectively. Moreover, the anchoring protrusion 148 has an outer diameter which is larger than an outer diameter of each of the reaction protrusions 142. As a result, the anchoring protrusion 148 may provide a large area of contact between the reaction element 134 and the hub 104, which may serve to stabilise the tool 108 when it is held in the position shown in FIG. 1.

When the tool 108 is arranged as shown in FIG. 1, i.e. with the socket 132 and the reaction element 134 simultaneously engaging the nut 106 and the reaction surface 126 (respectively), the gearbox in the tool 108 can be operated to apply opposing torques to the nut 106 and the reaction surface 126. In particular, when the tool 108 is arranged as in FIG. 1, the common axis 136 of rotation of the socket 132 and the reaction element 134 is aligned with the axis 103 of the hub 104, such that the socket 132 and the reaction element 134 can be used to apply torques about the axis 103 of the hub 104. To operate the tool 108, an input torque may be provided to the input fitting 138, which is converted by the gearbox into a first output torque applied to the socket 132 and a second, opposing output torque applied to the reaction element 134. The first output torque may then be transmitted from the socket 132 to the nut 106 (via engagement of the engagement protrusions 140 in the engagement openings 122), which may cause the nut 106 to be tightened or loosened on the threaded surface 116, depending on the direction of the torque. The second output torque may be transmitted to the reaction surface 126 (via engagement of the reaction protrusions 142 in the reaction openings 128), which may prevent the hub 104 and the wheel 102 from being rotated with the nut 106. In other words, the torque applied to the reaction surface 126 by the reaction element 134 may counteract the torque applied to the nut 106 by the socket 132, to avoid unwanted rotation of the wheel 102 during tightening or loosening of the nut 106. Additionally, engagement of the anchoring protrusion 148 in the anchoring opening 150 may act to stabilise the tool 108 during application of the opposing torques via the socket 132 and the reaction element 134.

As the nut 106 is tightened or loosened it will travel in a longitudinal direction along, e.g. forwards or backwards along the axis 103 of the hub 104 depending on its direction of rotation. For example, the nut may travel about 3-5 mm along the axis 103 as it is tightened onto the hub 104. As a result, the nut 106 may move relative to the engagement protrusions 140 as it is tightened or loosened. Thus, a length of the engagement protrusions 140 may be adapted to ensure that the engagement protrusions 140 can remain engaged in the engagement openings 122 when the nut 106 is fully tightened on the hub 104, so that a torque can be applied to the nut 106 when it is in a fully tightened position.

Similarly, a length of the reaction protrusions 142 may be adapted to ensure that the reaction protrusions 142 can engage the reaction openings 128 over an entire range of travel of the nut 106 on the hub 104. This may ensure that the engagement protrusions 140 and the reaction protrusions 142 can simultaneously engage the engagement openings 122 and the reaction openings 128, respectively, when the nut 106 is in a fully loosened position on the hub 104. This may facilitate rapid engagement of the tool 108, thus enabling rapid tightening and loosening of the nut 106.

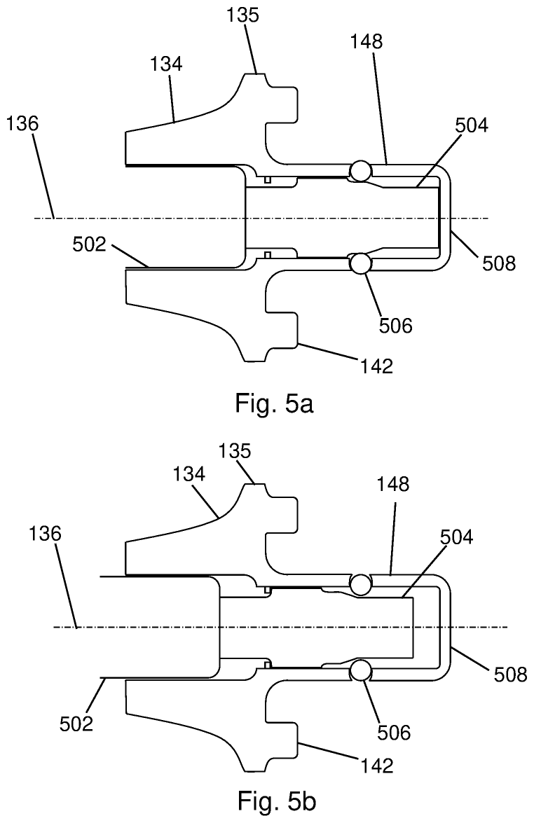

In some embodiments, the anchoring protrusion 148 may include an engagement mechanism for releasably engaging a side surface inside the anchoring opening 150, to strengthen engagement between the anchoring protrusion 148 and the anchoring opening 150. For example, the anchoring protrusion 148 may include a ball detent mechanism, as shown in FIGS. 5a-5b which depict cross-sectional side views of the reaction element 134. In the example of FIGS. 5a-5b, the reaction element 134 is slidably mounted on a shaft 502 which is connected to an end of the body 130 of the tool 108. The reaction element 134 is mounted on the shaft 502, such that it is movable along (e.g. backwards and forwards along) the shaft 502, the shaft 502 extending along the axis 136 of the tool 108. In particular, a central longitudinal bore is formed in a body of the reaction element 134, the shaft 502 being received in the channel so that the reaction element 134 can move along the shaft 502. The reaction element 134 is movable along the shaft 502 between a retracted state (shown in FIG. 5a) where it is retracted towards the body 130 of the tool 108, and an extended state (shown in FIG. 5b) where it is located further from the body 130 of the tool 108.

The anchoring protrusion 148 is hollow, and a distal portion 504 of the shaft 502 extends into the hollow anchoring protrusion 148. The anchoring protrusion 148 includes a set of apertures formed in a sidewall of the anchoring protrusion 148, with a respective ball-bearing 506 being held in each aperture. The distal portion 504 of the shaft 502 has a tapered shape arranged such that, when the reaction element 134 is in the retracted state (FIG. 5a), the distal portion 504 of the shaft 502 presses the ball-bearings outwards so that they protrude from the apertures, i.e. so that they protrude beyond the sidewall of the anchoring protrusion 148. Conversely, when the reaction element 134 is in the extended state (FIG. 5b), the tapered shape of the distal portion 504 of the shaft 502 is arranged such that it does not press the ball-bearings 506 outwards. Thus, when the reaction element 134 is in the extended state, the ball-bearings can retract within the apertures so that they do not protrude beyond the sidewall of the anchoring protrusion 148.

Accordingly, when the anchoring protrusion 148 is engaged in the anchoring opening 150 and the reaction element 134 is in the retracted state, the ball-bearings 506 will be pressed outwards, such that they press against a side surface of the hub 104 inside the reaction opening 150. Thus, when the reaction element 134 is in the retracted state, the ball-bearings 506 may serve to provide a tight fit between the anchoring protrusion 148 and the anchoring opening 150, increasing a strength and stability with which the anchoring protrusion 148 is held within the anchoring opening 150. Then, when the reaction element 134 is moved to the extended state, the ball-bearings 506 may disengage from the side surface of the hub 104 inside the reaction opening 150, so that the anchoring protrusion 148 can be easily removed from the anchoring opening 150. In use, when the tool 108 is offered towards the hub, the reaction element 134 may be in the extended state, such that the anchoring protrusion 148 can be inserted into the anchoring opening 150 with minimal resistance. As the tool 108 is advanced further towards the hub 104, an end face 508 of the anchoring protrusion 148 will abut against an end surface inside the anchoring opening 150 whilst the reaction element 134 will engage the reaction surface 126, which causes the reaction element 134 to move back along the shaft 502 towards the body 130 of the tool 108. In other words, engagement of the anchoring protrusion 148 in the anchoring opening 150 (and/or of the reaction element 134 with the reaction surface 126) causes the reaction element 134 to move from the extended state to the retracted state. Thus, the reaction element 134 may be automatically moved from the extended state to the retracted state when the anchoring protrusion 148 reaches the end surface the anchoring opening 150, ensuring a strong and stable engagement of the anchoring protrusion 148 in the anchoring opening 150. Subsequently, when the tool 108 is pulled away from the hub 104, this will cause the body 130 and the shaft 502 to move back relative to the reaction element 134, thus placing the reaction element 134 in the extended state. The ball-bearings 506 can then retract into the apertures, so that the anchoring protrusion 148 can be withdrawn from the anchoring opening 150. In this manner, the reaction element 134 may automatically move from the retracted state to the extended state when the tool 108 is pulled away from the hub 104, thus facilitating disengaging the anchoring protrusion 148 from the anchoring opening 150.

FIGS. 6a and 6b illustrate an example gear system 600 that may be included in a gearbox of a tool of the invention. For example, the gearbox of the tool 108 discussed above may include the gear system 600. FIG. 6a shows a front cross-sectional view of the gear system 600, whilst FIG. 6b shows a side cross-sectional view of the gear system 600. The cross-sectional view of FIG. 6b is taken along the plane B-B shown in FIG. 6a.

The gear system 600 is a planetary gear system, including a central sun gear 602 and a set of four planet gears 604 arranged around the sun gear 602. The sun gear 602 is rotatable about a central axis 603, which may be aligned with an axis of rotation of a socket and a reaction element of the tool (e.g. axis 136 of the tool 108). The cross-sectional view of FIG. 6a is in a plane normal to the central axis 603. The planet gears 604 mesh with the sun gear 602, such that rotation of the sun gear 602 causes rotation of the planet gears 604 about their respective axes of rotation. The planet gears 604 are each connected to a carrier 606, which includes a frame to which four axles are connected, with a respective one of the planet gears 604 being rotatably mounted on each of the axles. The gear system 600 further includes a ring gear 608 disposed around the planet gears 604, such that each of the planet gears 604 meshes with the ring gear 608. In other words, each of the planet gears 604 meshes on one side with the sun gear 602 and on another side with the ring gear 608. For illustration purposes, gear teeth of the sun gear 602, the planet gears 604 and the ring gear 608 are not shown in FIGS. 6a and 6b. The dashed lines in FIGS. 6a and 6b show the pitch circle diameters (PCD) for each of the sun gear 602, the planet gears 604 and the ring gear 608, and therefore are representative of locations of the gear teeth for these parts.

In use, an input of the gearbox (e.g. input fitting 138) may be connected to the sun gear 602, such that the sun gear 602 is arranged to receive an input torque. Then one of the ring gear 608 and the carrier 606 may be connected to a socket (e.g. socket 132) of the tool, whilst the other one of the ring gear 608 and the carrier 606 may be connected to a reaction element (e.g. reaction element 134) of the tool. The part of the gear system 600 which is connected to the reaction element may act as a fixed part of the gear system 600, as its rotational position may remain substantially fixed in use due to engagement of the reaction element with the reaction surface. For example, where the ring gear 608 is configured as the fixed part of the gear system 600, rotation of the sun gear 602 about its central axis 603 may cause the centres of the planet gears 604, and thus the carrier 606, to rotate about the axis 603, whilst a rotational position of the ring gear 608 may remain substantially fixed due to engagement of the reaction element with the reaction surface. On the other hand, where the carrier 606 is configured as the fixed part of the gear system 600, rotation of the sun gear 602 about the axis 603 may cause the ring gear 608 to rotate about the axis 603, whilst rotational positions of the centres of the planet gears 604 and the carrier 606 remain substantially fixed due to engagement of the reaction element with the reaction surface.

In more detail, where the carrier 606 is configured as the fixed part of the gear system 600, the carrier 606 is connected to the reaction element of the tool (e.g. reaction element 134), i.e. so that the carrier 606 can apply a torque to the reaction element about the axis 603. The ring gear 608 may then be connected to a socket of the tool (e.g. socket 132), i.e. so that the ring gear 608 can apply a torque to the socket about the axis 603. In this manner, when an input torque in a first direction is applied to the input of the gearbox, the input torque causes the sun gear 602 to rotate in the first direction about the central axis 603. This causes the planet gears 604 to rotate about their respective axes in second direction (opposite to the first direction), which in turn causes the ring gear 608 to rotate around the central axis 603 in the second direction. Thus, the carrier 606 and the ring gear 608 may experience torques of similar magnitudes but in opposing directions. As a result, opposing torques may be applied to the socket and the reaction element which, as discussed above, may serve to prevent unwanted rotation of the wheel when the nut is tightened or loosened on the hub. Moreover, the magnitude of the torque experienced by the ring gear 608 (and hence by the socket) will be stepped up compared to the input torque, by a ratio of R=N_{R}/N_{S}, and the magnitude of the torque experienced by the carrier 606 (and hence by the reaction element) will be stepped up compared to the input torque, by a ratio of R=1+N_{R}/N_{S}, where N_{R} is a number of teeth on the ring gear 608 and N_{S} is a number of teeth on the sun gear 602. In such an embodiment, rotational positions of the centres of the planet gears 604 and the carrier 606 may remain substantially fixed during use, as the torque applied by the reaction element to the reaction surface counteracts the torque applied to the nut, to avoid rotation of the wheel.

In embodiments where the ring gear 608 is configured as the fixed part of the gear system 600, the ring gear 608 is connected to the reaction element of the tool (e.g. reaction element 134), i.e. so that the ring gear 608 can apply a torque to the reaction element about the axis 603. The carrier 606 may then be connected to a socket of the tool (e.g. socket 132), i.e. so that the carrier 606 can apply a torque to the socket about the axis 603. In this manner, when an input torque in a first direction is applied to the input of the gearbox, the input torque causes the sun gear 602 to rotate in the first direction about the central axis 603. This causes the planet gears 604 to rotate about their respective axes in second direction (opposite to the first direction), which in turn causes the carrier 606 to rotate around the central axis 603 in the first direction. Thus, the carrier 606 and the ring gear 608 may experience torques of equal magnitudes but in opposing directions. As a result, opposing torques may be applied to the socket and the reaction element which, as discussed above, may serve to prevent unwanted rotation of the wheel when the nut is tightened or loosened on the hub. Moreover, the magnitude of the torque experienced by the carrier 606 (and hence by the socket) will be stepped up compared to the input torque, by a ratio of R=1+N_{R}/N_{S} and the magnitude of the torque experienced by the ring gear 608 (and hence by the reaction element) will be stepped up compared to the input torque, by a ratio of R=N_{R}/N_{S}, where N_{R} is a number of teeth on the ring gear 608 and N_{S} is a number of teeth on the sun gear 602. In such an embodiment, a rotational position of the ring gear 608 may remain substantially fixed during use, as the torque applied by the reaction element to the reaction surface counteracts the torque applied to the nut, to avoid rotation of the wheel.

It should be noted that various modifications may be made to the embodiments discussed above, without departing from the scope of the invention. For example, in the system 100 discussed above, the reaction surface 126 is provided on the hub 104. However, in other embodiments, the reaction surface 126 may instead be provide on the wheel 102, e.g. in a region surrounding the centre hole 110 of the wheel 102. The tool 108 may then be modified accordingly, to enable simultaneous engagement of the socket 132 and the reaction element 134 with the nut 106 and the reaction surface 126, respectively. For example, instead of being provided inside the socket 132, the reaction element 134 may be provided concentrically around the socket 132, to enable it to engage the reaction surface 126 on the wheel 102. Additionally the system 100 is described as having various pairs of protrusions and corresponding openings (e.g. reaction protrusions 142 and reaction openings 128; engagement protrusions 140 and engagement openings 122; anchoring protrusion 148 and anchoring opening 150). It will be understood that, in other embodiments, the locations of the protrusions and corresponding openings in each pair can be swapped compared with the arrangement disclosed for the system 100.

1. A wheel fastening system for a vehicle, the wheel fastening system comprising:
a hub on which a wheel is mountable, the hub comprising a threaded surface;
a nut which is engageable with the threaded surface to fasten the wheel to the hub; and
a tool comprising:
a socket that is engageable with the nut;
a reaction element that is engageable with a reaction surface on the hub or the wheel, wherein, when the wheel is mounted on the hub and the nut is engaged with the threaded surface, the socket and the reaction element are simultaneously engageable with the nut and the reaction surface, respectively; and
a gearbox configured to simultaneously apply opposing torques to the socket and the reaction element.

2. The wheel fastening system according to claim 1,
wherein the socket is arranged concentrically around the reaction element, and wherein the reaction surface is located on the hub, or
wherein the reaction element is arranged concentrically around the socket, and wherein the reaction surface is located on the wheel.

3. (canceled)

4. The wheel fastening system according to claim 1, wherein the reaction element comprises a first set of reaction features which are engageable with a second set of reaction features on the reaction surface.

5. The wheel fastening system according to claim 4, wherein the first set of reaction features and the second set of reaction features are arranged in a ring about a central axis of the hub when the reaction element is engaged with the reaction surface.

6. The wheel fastening system according to claim 4 or 5, wherein a first one of the first set and the second set of reaction features includes a set of reaction protrusions and a second one of the first set and second set of reaction features includes a set of reaction openings in which the reaction protrusions are engageable.

7. The wheel fastening system according to claim 6,
wherein each of the reaction protrusions has an end with a rounded or chamfered edge, or
wherein each of the reaction protrusions has a cross-sectional area that does not increase towards the end of the reaction protrusion, and/or that tapers towards an end of the reaction protrusion, or
wherein each reaction opening has an area that is larger than a maximum cross-sectional area of each of the reaction protrusions, or
wherein each reaction opening has a first angular extent that is larger than a second angular extent of each of the reaction protrusions, the first angular extent and the second angular extent being defined relative to a central axis of the hub when the reaction element is engaged with the reaction surface.

8. (canceled)

9. (canceled)

10. (canceled)

11. The wheel fastening system according to claim 1,
wherein the tool further comprises a first anchoring feature that is configured to engage a second anchoring feature on the hub when the socket and the reaction element are engaged with the nut and the reaction surface, respectively, or
wherein the first anchoring feature is part of the reaction element.

12. (canceled)

13. The wheel fastening system according to claim 11, wherein a first one of the first anchoring feature and the second anchoring feature includes an anchoring protrusion and a second one of the first anchoring feature and the second anchoring feature includes an anchoring opening in which the anchoring protrusion is engageable.

14. The wheel fastening system according to claim 13, wherein the anchoring protrusion is arranged such that the anchoring protrusion engages the anchoring opening before the socket and the reaction element engage the nut and the reaction surface, respectively, when the tool is offered towards the hub along the axis of the hub.

15. The wheel fastening system according to one of claim 11, wherein the first anchoring feature is arranged so that it is centered about a central axis of the hub when the socket and the reaction element are engaged with the nut and the reaction surface, respectively.

16. The wheel fastening system according to claim 15, wherein the first anchoring feature and the second anchoring feature have circular cross-sections.

17. A wheel fastening system according to claim 11, wherein a first one of the first anchoring feature and the second anchoring feature comprises an engagement mechanism configured to releasably engage a side surface of a second one of the first anchoring feature and the second anchoring feature when the first anchoring feature is engaged with the second anchoring feature.

18. The wheel fastening system according to claim 17, wherein the engagement mechanism comprises a ball detent mechanism.

19. The wheel fastening system according to claim 1, wherein the socket comprises a set of socket features which are engageable with a set of engagement features on the nut.

20. The wheel fastening system according to claim 19, wherein the set of socket features and the set of engagement features are arranged in a ring about a central axis of the hub when the socket is engaged with the nut.

21. The wheel fastening system according to claim 19, wherein a first one of the set of socket features and the set of engagement features includes a set of engagement protrusions and a second one of the set of socket features and the set of engagement features includes a set of engagement openings in which the engagement protrusions are engageable.

22. The wheel fastening system according to claim 21,
wherein each of the engagement protrusions has an end with a rounded or chamfered edge, or
wherein each of the engagement protrusions has a cross-sectional area that does not increase towards an end of the engagement protrusion, and/or that tapers towards an end of the engagement protrusion.

23. (canceled)

24. The wheel fastening system according to claim 1, wherein the gearbox comprises a planetary gear system, or
wherein the planetary gear system comprises a sun gear, a ring gear and one or more planet gears, and wherein an input of the gearbox is connected to the sun gear, one of the socket and the reaction element is connected to the ring gear, and another one of the socket and the reaction element is connected to the one or more planet gears.

25. (canceled)

26. The wheel fastening system according to claim 1, further comprising a motor configured to apply a torque to an input of the gearbox.

27. A vehicle comprising a wheel fastening system according to claim 1.
